(19) United States
(12) Patent Application Publication
(10) Pub. No.: US 2008/0211615 A1
(43) Pub. Date: Sep. 4, 2008

(54) INVERTER TRANSFORMER

(75) Inventors: Masakazu Ushijima, Nakano-ku (JP); Chun-Yi Chang, Taipei Hsien (TW)

Correspondence Address: DARBY & DARBY P.C., P.O. BOX 770, Church Street Station, New York, NY, 10008-0770, US

(73) Assignees: Greatchip Technology Co., Ltd., Taichung (TW); Yao Sheng Electronic Co., Ltd., Taipei Hsien (TW)

(21) Appl. No.: 12/043,947

(22) Filed: Mar. 6, 2008

Related U.S. Application Data
(63) Continuation-in-part of application No. 11/240,942, filed on Sep. 29, 2005, now Pat. No. 7,365,501.

(51) Int. Cl. H01F 27/28

(52) U.S. Cl. 336/170

(57) ABSTRACT

An inverter transformer includes a coil unit and a transformer core unit. The coil unit includes a bobbin formed with a core-receiving compartment, and a plurality of windings including two primary windings and two secondary windings wound around the bobbin. The secondary windings are disposed adjacent to each other and are coupled electromagnetically and respectively to the primary windings. The transformer core unit includes an internal core part that extends into the core-receiving compartment of the bobbin, and an external core part that forms a magnetic circuit path with the internal core part. The external core part includes a main segment extending externally at one side of the bobbin and a protrusion segment extending from the main segment toward a portion of the bobbin that is disposed between the secondary windings.

### CROSS-REFERENCE TO RELATED APPLICATION

This application is a continuation-in-part (CIP) of U.S. patent application Ser. No. 11/240,942, entitled “INVERTER TRANSFORMER”, filed on Sep. 29, 2005.

### BACKGROUND OF THE INVENTION

1. Field of the Invention

The invention relates to an inverter transformer, more particularly to an inverter transformer adapted to drive illumination of discharge lamps.

2. Description of the Related Art

An inverter circuit is the main component that drives illumination of discharge lamps. When an inverter is adapted for driving a plurality of discharge lamps simultaneously, supply of balanced current outputs to the discharge lamps is the key to ensuring uniform illumination among the discharge lamps.

### SUMMARY OF THE INVENTION

Therefore, the object of the present invention is to provide an inverter transformer that is adapted to supply balanced current outputs to discharge lamps so as to ensure uniform illumination.

According to one aspect of the present invention, there is provided an inverter transformer that includes a coil unit and a transformer core unit. The coil unit includes a bobbin formed with a core-receiving compartment, and a plurality of windings including two primary windings and two secondary windings wound around the bobbin. The secondary windings are disposed adjacent to each other and are coupled electromagnetically and respectively to the primary windings. The transformer core unit includes an internal core part that extends into the core-receiving compartment of the bobbin, and an external core part that forms a magnetic circuit path with the internal core part. The external core part includes a main segment extending externally at one side of the bobbin and a protrusion segment extending from the main segment toward a portion of the bobbin that is disposed between the secondary windings.

According to another aspect of the present invention, there is provided an inverter transformer that includes a plurality of coil units and a plurality of transformer core units. Each of the coil units includes a bobbin formed with a core-receiving compartment, and a plurality of windings including primary, secondary and tertiary windings wound around the bobbin. The secondary and tertiary windings are coupled electromagnetically to the primary winding. Each of the transformer core units has an internal core part that extends into the core-receiving compartment of a respective one of the coil units. The tertiary windings of the coil units are interconnected to form a closed circuit loop.

According to still another aspect of the present invention, there is provided an inverter transformer that includes a plurality of coil units and a plurality of transformer core units. Each of the coil units includes a bobbin formed with a core-receiving compartment, and a plurality of windings including two primary windings and two secondary windings wound around the bobbin. The secondary windings of each of the coil units are disposed adjacent to each other and are coupled electromagnetically and respectively to the primary windings of the corresponding one of the coil units. Each of the transformer core units includes an internal core part that extends into the core-receiving compartment of the bobbin of a respective one of the coil units, and an external core part that forms a magnetic circuit path with the internal core part. The external core part includes a main segment extending externally at one side of the bobbin of the respective one of the coil units and a protrusion segment extending from the main segment toward a portion of the bobbin of the respective one of the coil units that is disposed between the secondary windings.

The plurality of windings of each of the coil units further includes a tertiary winding wound around the bobbin of the respective one of the coil units and coupled electromagnetically to the primary windings of the respective one of the coil units. The tertiary windings of the coil units are interconnected.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of the first preferred embodiment of an inverter transformer according to the present invention;

FIG. 2 is a schematic diagram of the second preferred embodiment of an inverter transformer according to the present invention;

FIG. 3 is schematic diagram of the third preferred embodiment of an inverter transformer according to the present invention;

FIG. 4 is a schematic diagram of a first configuration of the fourth preferred embodiment of an inverter transformer according to the present invention;

FIG. 5 is a schematic diagram of a second configuration of the fourth preferred embodiment; and

FIG. 6 is a schematic diagram of the fifth preferred embodiment of an inverter transformer according to the present invention.

### DETAILED DESCRIPTION OF THE PREFERRED EMBODIMENTS

Before the present invention is described in greater detail, it should be noted that like elements are denoted by the same reference numerals throughout the disclosure.

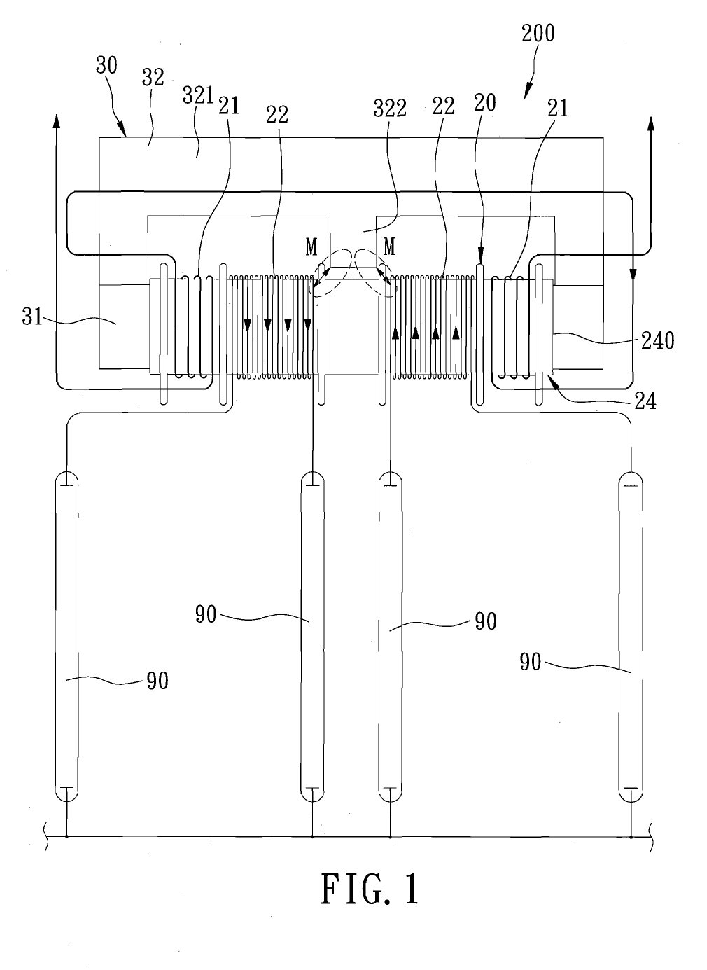

As shown in FIG. 1, the first preferred embodiment of an inverter transformer 200 according to the present invention is adapted to be coupled to a plurality of loads 90, each of which is a discharge lamp in this embodiment. The inverter transformer 200 includes a coil unit 20 and a transformer core unit 30.

The coil unit 20 includes a bobbin 24 formed with a core-receiving compartment 240, two primary windings 21, and two secondary windings 22 disposed adjacent to each other and coupled electromagnetically and respectively to the primary windings 21.

The primary windings 21 are connected in series to each other. During operation, the secondary windings 22 have electromagnetic fields that oppose each other. The secondary windings 22 are adapted to be coupled electrically to the loads 90. In this embodiment, each end of each of the secondary windings 22 is adapted to be connected electrically to a corresponding end of a corresponding one of the loads 90. The other ends of the loads 90 are connected to each other.

The transformer core unit 30 includes an internal core part 31 that extends into the core-receiving compartment 240 of the bobbin 24, and an external core part 32 that is disposed outside of the core-receiving compartment 240 of the bobbin 24. The external core part 32 forms a magnetic circuit path with the internal core part 31. The external core part 32 includes a main segment 321 extending externally at one side of the bobbin 24, and a protrusion segment 322 extending from the main segment 321 toward a portion of the bobbin 24 that is disposed between the secondary windings 22. In this embodiment, the external core part 32 is configured as an E-shaped core, and the main segment 321 extends parallel to the bobbin 24.

The following relation is applicable to the design of the protrusion segment 322 extending toward the portion of the bobbin 24 that is disposed between the secondary windings 22:

$$magnetic path length = \frac{physical distance of flux path}{cross \text{-} sectional area of core}$$

This way, the effective magnetic path length is increased, and cross interference between induced fluxes in the secondary windings 22 due to mutual inductance established therebetween is reduced, thereby achieving the object of balancing and stabilizing currents flowing through the secondary windings 22.

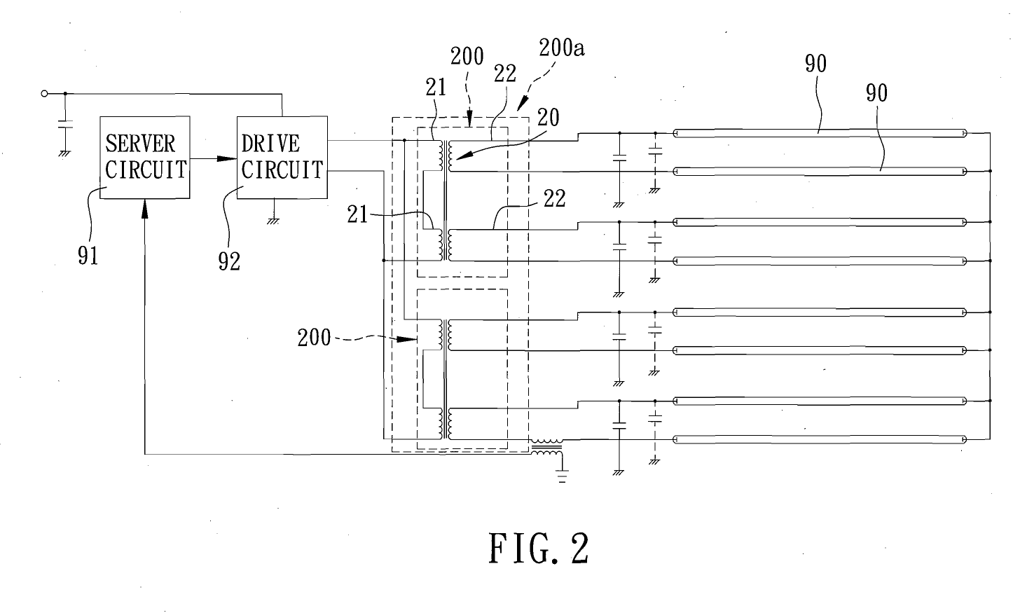

As shown in FIG. 2, the second preferred embodiment of an inverter transformer 200a according to the present invention basically includes two of the transformers 200 of the first preferred embodiment, i.e., the inverter transformer 200a of the second preferred embodiment includes two of the coil units 20 and two of the transformer core units 30 (as shown in FIG. 1). The inverter transformer 200a is adapted to be integrated with a server circuit 91 and a drive circuit 92 so as to form a backlight module for a liquid crystal display. The primary windings 21 of each of the coil units 20 are connected in series to each other and to the drive circuit 92, while the series-connected primary windings 21 of a first one of the coil units 20 are connected in parallel to the series-connected primary windings 21 of a second one of the coil units 20. The inverter transformer 200a of the second preferred embodiment also achieves the object of balancing and stabilizing currents flowing through the secondary windings 22.

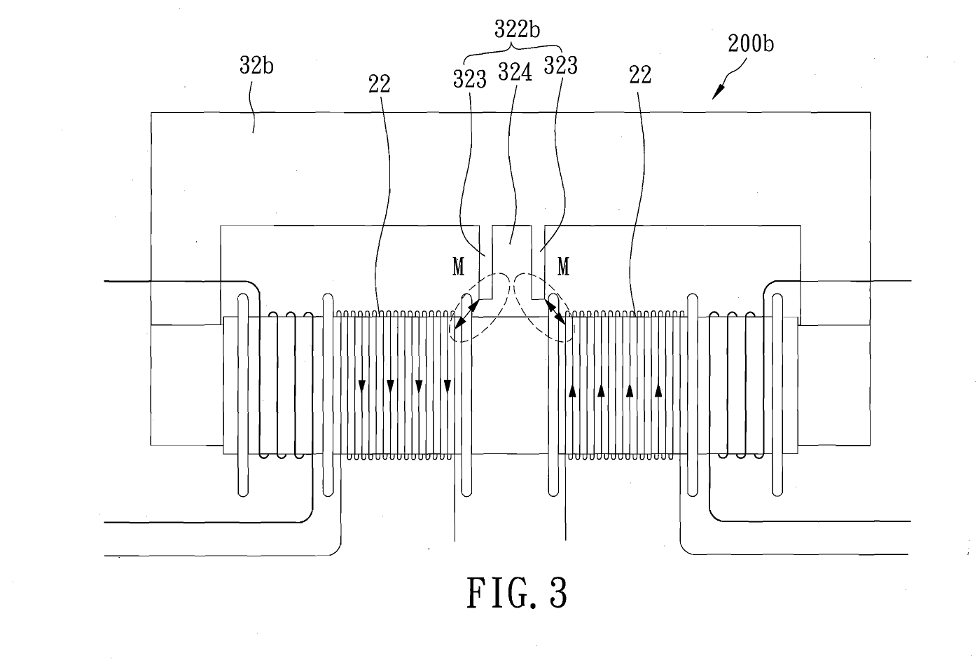

As shown in FIG. 3, the third preferred embodiment of an inverter transformer 200b according to the present invention differs from the first preferred embodiment in that the protrusion segment 322b of the external core part 32b has two spaced-apart protrusion portions 323 that are respectively disposed proximate to the secondary windings 22 and that cooperate to form an air gap 324 therebetween.

This way, the mutual inductance established between the secondary windings 22 is reduced, thereby achieving the object of balancing and stabilizing currents flowing through the secondary windings 22.

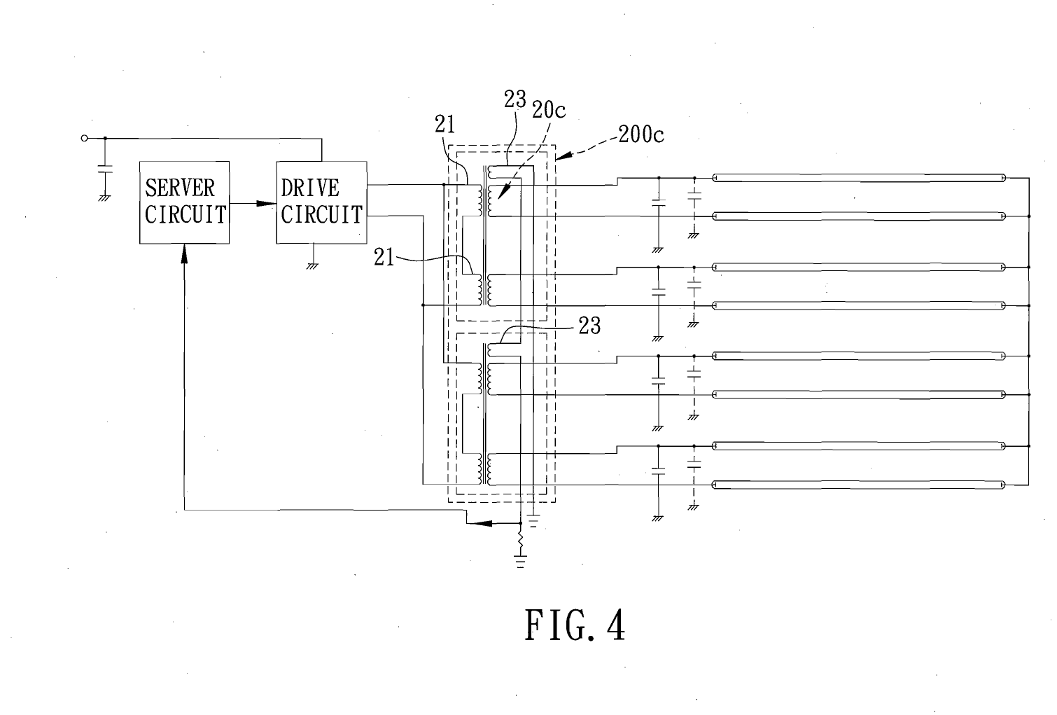

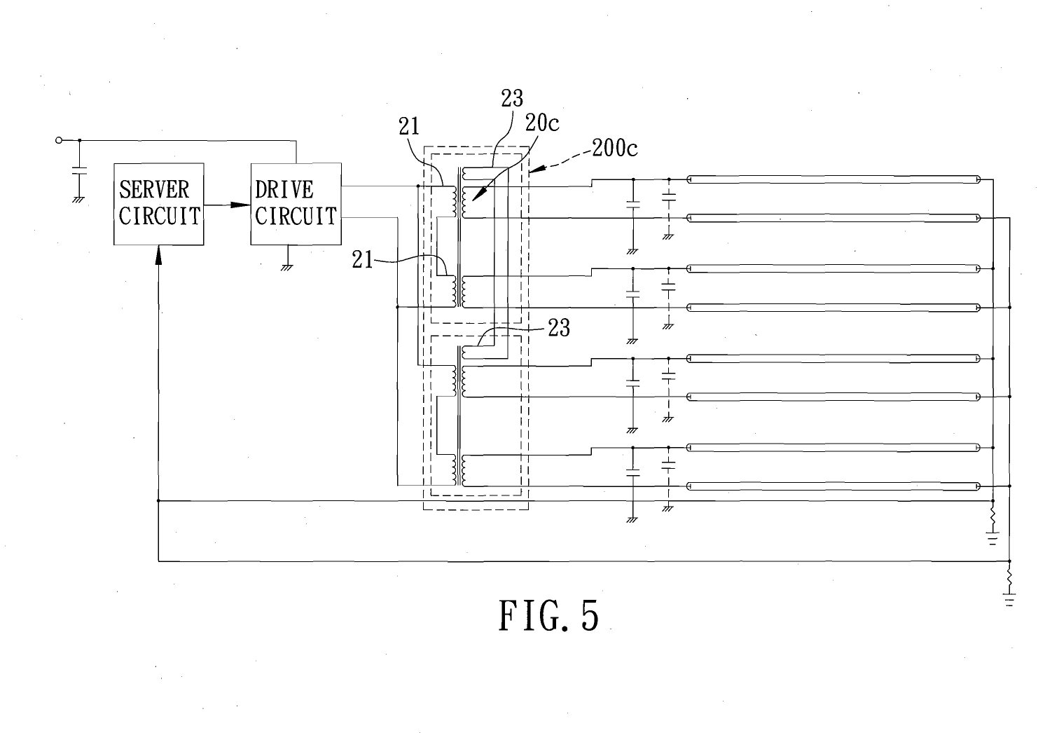

As shown in FIG. 4 and FIG. 5, the fourth preferred embodiment of an inverter transformer 200c according to the present invention differs from the second preferred embodiment in that each of the coil units 20c further includes a tertiary winding 23 coupled electromagnetically to the primary windings 21. The tertiary windings 23 of the coil units 20c are interconnected to form a closed circuit loop, where each of the tertiary windings 23 may be grounded at one end (as shown in FIG. 4), or may be directly interconnected (as shown in FIG. 5).

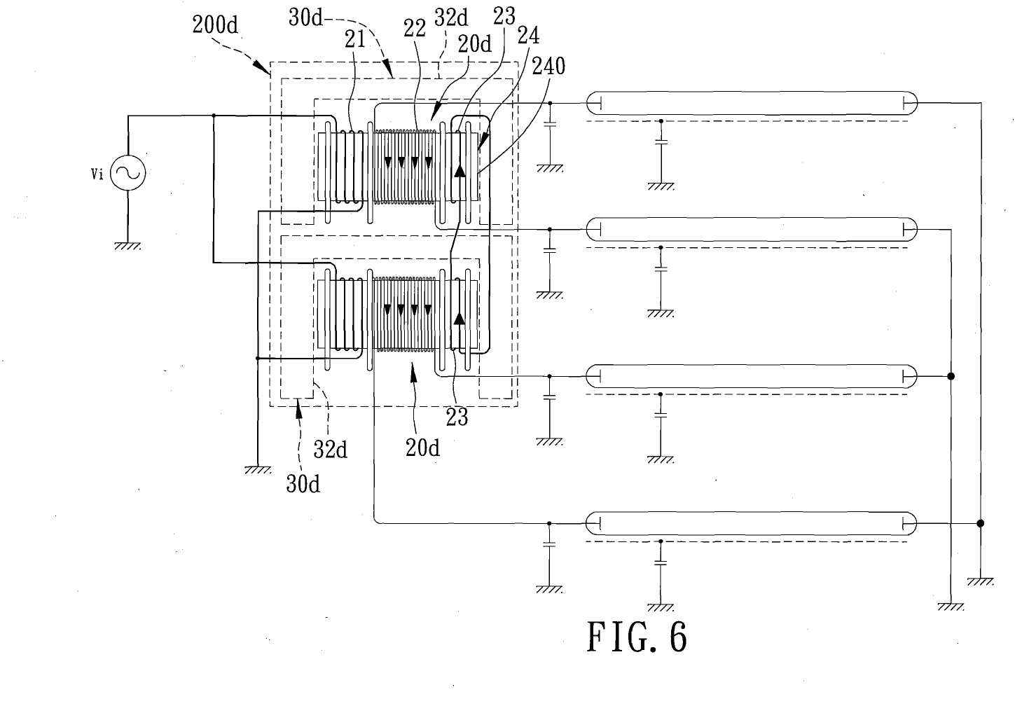

As shown in FIG. 6, the fifth preferred embodiment of an inverter transformer 200d according to the present invention includes a plurality of coil units 20d, each of which includes a bobbin 24 formed with a core-receiving compartment 240, and a plurality of windings including a primary winding 21, a secondary winding 22 and a tertiary winding 23 wound around the bobbin 24. The secondary and tertiary windings 22, 23 of each of the coil units 20d are coupled electromagnetically to the primary winding 21 of the corresponding one of the coil units 20d. In addition, the secondary winding 22 of each of the coil units 20d is disposed between the primary and tertiary windings 21, 23 of the corresponding one of the coil units 20d. The tertiary windings 23 of the coil units 20d are interconnected to form a closed circuit loop.

The inverter transformer 200d further includes a plurality of transformer core units 30d, each of which has an internal core part (not shown) that extends into the core-receiving compartment 240 of a respective one of the coil units 20d, and an external core part 32d that is disposed externally of the core-receiving compartment 240 and that forms a magnetic circuit path with the internal core part.

In this embodiment, since each of the coil units 20d only includes one secondary winding 22, the mutual inductance established between the secondary windings 22 of the previous embodiments is eliminated. In addition, by connecting the tertiary windings 23 of the coil units 20d in series to each other, the object of establishing balanced and stable output currents at the secondary windings 22 is achieved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An inverter transformer comprising:
a coil unit including
a bobbin formed with a core-receiving compartment, and
a plurality of windings including two primary windings and two secondary windings wound around said bobbin, said secondary windings being disposed adjacent to each other and being coupled electromagnetically and respectively to said primary windings; and
a transformer core unit including an internal core part that extends into said core-receiving compartment of said bobbin, and an external core part that forms a magnetic circuit path with said internal core part, said external core part including a main segment extending externally at one side of said bobbin and a protrusion segment extending from said main segment toward a portion of said bobbin that is disposed between said secondary windings.

2. The inverter transformer as claimed in claim 1, wherein said primary windings are connected in series to each other, said secondary windings having electromagnetic fields that oppose each other and being adapted to be coupled electrically to a plurality of loads.

3. The inverter transformer as claimed in claim 1, wherein said protrusion segment of said external core part has two spaced-apart protrusion portions that are respectively disposed proximate to said secondary windings and that cooperate to form an air gap therebetween.

4. The inverter transformer as claimed in claim 1, wherein said coil unit further includes a tertiary winding coupled electromagnetically to said primary windings.

5. An inverter transformer comprising:
a plurality of coil units, each including
a bobbin formed with a core-receiving compartment, and
a plurality of windings including primary, secondary and tertiary windings wound around said bobbin, said secondary and tertiary windings being coupled electromagnetically to said primary winding; and
a plurality of transformer core units, each having an internal core part that extends into said core-receiving compartment of a respective one of said coil units;
wherein said tertiary windings of said coil units are interconnected to form a closed circuit loop.

6. The inverter transformer as claimed in claim 5, wherein said secondary winding is disposed between said primary and tertiary windings.

7. An inverter transformer comprising:
a plurality of coil units, each including
a bobbin formed with a core-receiving compartment, and
a plurality of windings including two primary windings and two secondary windings wound around said bobbin, said secondary windings being disposed adjacent to each other and being coupled electromagnetically and respectively to said primary windings; and
a plurality of transformer core units, each including
an internal core part that extends into said core-receiving compartment of said bobbin of a respective one of said coil units, and
an external core part that forms a magnetic circuit path with said internal core part, said external core part including a main segment extending externally at one side of said bobbin of the respective one of said coil units and a protrusion segment extending from said main segment toward a portion of said bobbin of the respective one of said coil units that is disposed between said secondary windings;
wherein said plurality of windings of each of said coil units further includes a tertiary winding wound around said bobbin of the respective one of said coil units and coupled electromagnetically to said primary windings of the respective one of said coil units, said tertiary windings of said coil units being interconnected.
